(19) United States
(12) Patent Application Publication
(10) Pub. No.: US 2025/0233169 A1
(43) Pub. Date: Jul. 17, 2025

(54) FUEL CELL STACK

(71) Applicant: Honda Motor Co., Ltd., Tokyo (JP)

(72) Inventor: Kenji Nagumo, Wako-shi (JP)

(21) Appl. No.: 19/001,496

(22) Filed: Dec. 25, 2024

(30) Foreign Application Priority Data
Jan. 17, 2024 (JP) 2024-005006

(51) Int. Cl. H01M 8/0258; H01M 8/2465

(52) U.S. Cl. CPC H01M 8/0258; H01M 8/2465

(57) ABSTRACT

A fuel cell stack including a cell stacked body including a plurality of power generation cells stacked in a predetermined direction, a first end unit disposed on a first side in the predetermined direction of the cell stacked body, a second end unit disposed on a second side in the predetermined direction of the cell stacked body, and a tubular body disposed in a gas supply flow path of the cell stacked body and extending in the predetermined direction. The tubular body includes first and second end portions where first and second openings are provided, respectively, a water discharge passage is provided in a non-power generation region located on the second opening side and outside a power generation region of the cell stacked body so as to guide liquid water flowing out through the second opening to the gas discharge flow path.

### CROSS-REFERENCE TO RELATED APPLICATION

This application is based upon and claims the benefit of priority from Japanese Patent Application No. 2024-005006 filed on Jan. 17, 2024, the content of which is incorporated herein by reference.

### BACKGROUND OF THE INVENTION

### Field of the Invention

This invention relates to a fuel cell stack.

### Description of the Related Art

In recent years, technological developments have been made on a fuel cell that contribute to energy efficiency in order to ensure access to energy that is affordable, reliable, sustainable and advanced by more people. As a conventional technology related to this type of fuel cell, a fuel cell system is known in which a stirring mixer swirling fuel gas is provided in the flow path for supplying the fuel gas to the fuel cell stack to suppress the concentration of impurities such as water near the inlet of the fuel cell. Such a fuel cell stack is described, for example, in Japanese Unexamined Patent Publication No. 2019-145427 (JP 2019-145427 A).

However, as in the fuel cell system described in JP 2019-145427 A, providing the stirring mixer in the flow path for supplying the fuel gas to the fuel cell stack increases pressure loss in the flow path, hindering the smooth flow of the fuel gas.

### SUMMARY OF THE INVENTION

An aspect of the present invention is a fuel cell stack including: a cell stacked body including a plurality of power generation cells stacked in a predetermined direction, a gas supply flow path into which a reaction gas is supplied, a gas discharge flow path through which the reaction gas is discharged, and a gas flow path provided to communicate the gas supply flow path and the gas discharge flow path, the gas supply flow path and the gas discharge flow path being provided to extend in the predetermined direction; a first end unit disposed on a first side in the predetermined direction of the cell stacked body, a supply port communicating with the gas supply flow path and a discharge port communicating with the gas discharge flow path being provided in the first end unit; a second end unit disposed on a second side opposite to the first side in the predetermined direction of the cell stacked body; and a tubular body disposed in the gas supply flow path and extending in the predetermined direction. The tubular body includes a first end portion and a second end portion opposite to the first end portion, a first opening is provided at the first end portion of the tubular body so as to communicate with the gas supply flow path on an upstream side in a flow direction of the reaction gas, a second opening is provided at the second end portion of the tubular body so as to communicate with the gas supply flow path on a downstream side in the flow direction of the reaction gas, and a water discharge passage is provided in a non-power generation region located on the second side and outside a power generation region of the cell stacked body so as to guide a liquid water flowing out through the second opening to the gas discharge flow path.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack according to an embodiment of the present invention;

FIG. 2 is a perspective view showing a schematic configuration of a unitized electrode assembly included in the fuel cell stack of FIG. 1;

FIG. 3 is a cross-sectional view illustrating a main configuration of the fuel cell stack along a fuel gas supply flow path;

FIG. 4A is an enlarged view of a main part of FIG. 3 illustrating a configuration of a front support portion;

FIG. 4B is a view taken along an arrow IVB in FIG. 4A;

FIG. 5A is an enlarged view of a main part of FIG. 3 illustrating a configuration of a rear support portion;

FIG. 5B is a view taken along an arrow VB in FIG. 5A;

FIG. 6 is an enlarged view of a main part of a frame included in the unitized electrode assembly in FIG. 2;

FIG. 7 is a view schematically illustrating flows of fuel gas and liquid water in the fuel gas supply flow path of FIG. 3;

FIG. 8 is a view illustrating a modification of FIG. 7; and

FIG. 9 is a cross-sectional view illustrating a modification of a through-hole of the gas supply flow path provided in an end unit.

### DETAILED DESCRIPTION OF THE INVENTION

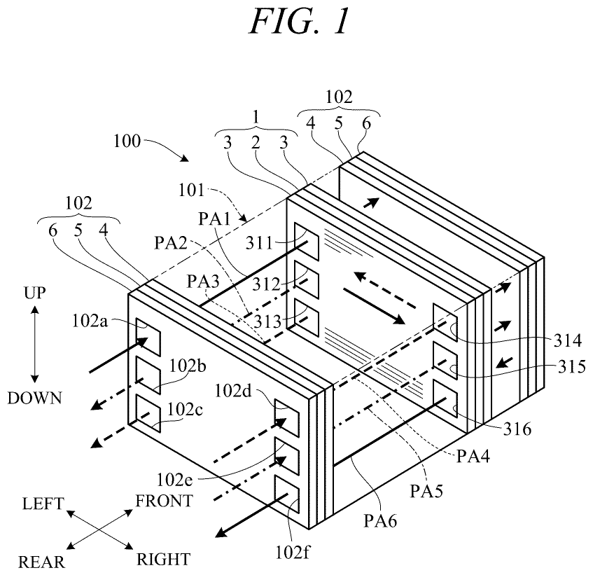

Hereinafter, an embodiment of the present invention will be described with reference to FIGS. 1 to 9. A fuel cell stack according to an embodiment of the present invention is a main component of a fuel cell. The fuel cell is mounted on, for example, a vehicle and can generate electric power for driving the vehicle. First, an overall configuration of the fuel cell stack will be schematically described.

FIG. 1 is a perspective view schematically showing an overall configuration of a fuel cell stack 100 according to the embodiment of the present invention. Hereinafter, for the sake of convenience, three-axis directions orthogonal to each other as illustrated in the drawing are defined as a front-rear direction, a left-right direction, and an up-down direction, and a configuration of each part will be described according to such definitions. The downward direction in the up-down direction corresponds to the direction of gravity, for example. The front-rear direction corresponds to the stacking direction of the fuel cell stack 100. The front-rear direction and left-right direction are not necessarily the same as the front-rear direction and left-right direction of the vehicle. For example, the front-rear direction in FIG. 1 may be the front-rear direction of the vehicle or the left-right direction of the vehicle.

As shown in FIG. 1, the fuel cell stack 100 has a cell stacked body 101 formed by stacking a plurality of power generation cells 1 in the front-rear direction, and end units 102 arranged at both ends in the front-rear direction of the cell stacked body 101, and the whole of the fuel cell stack 100 has a substantially rectangular parallelepiped shape. Although not shown, the periphery of the cell stacked body 101 is covered by a substantially rectangular parallelepiped-shaped case. The length of the cell stacked body 101 in the left-right direction is longer than its length in the up-down direction. For convenience, a single power generation cell 1 is shown in FIG. 1.

The power generation cell 1 has a unitized electrode assembly (hereinafter, referred to as a “UEA”) 2 including a joint body (a membrane electrode assembly) that includes an electrolyte membrane and electrodes, and separators 3 and 3 arranged on both sides in the front-rear direction of the UEA 2 to sandwich the UEA 2. The UEA 2 and the separator 3 are alternately arranged in the front-rear direction. The UEA 2 can also be referred to as a membrane electrode structure or a membrane electrode member.

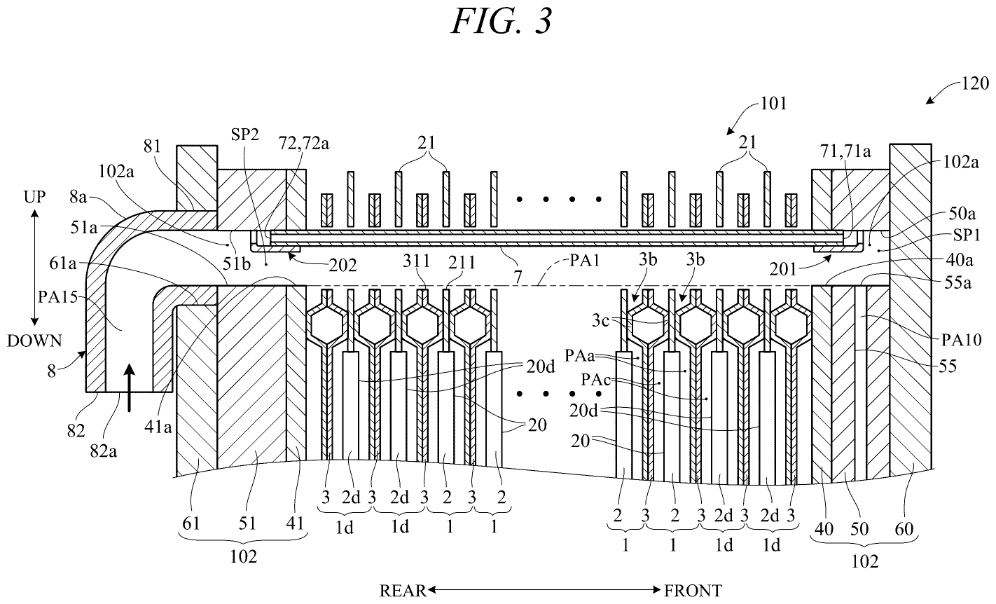

The separator 3 has a pair of front and rear plates, which are metal thin plates with a corrugated cross-section (see FIG. 3). The front and rear plates are integrally configured by being joined by welding or the like at their outer peripheral edges. The separator 3 uses a conductive material with excellent corrosion resistance, such as stainless steel, titanium, or titanium alloy. Inside the separator 3 (between the pair of thin plates), a cooling flow path PAw through which a cooling medium flows is formed. The generating surface of the power generation cell 1 is cooled by the flow of the cooling medium. Water, for example, can be used as the cooling medium. The surface of the separator 3 (front surface and rear surface) facing the UEA 2 is formed into an uneven shape by press molding or the like to form a gas flow path between the membrane electrode assembly of the UEA 2 and the separator 3.

The separator 3 on the front side of the UEA 2 is a separator (anode separator) on an anode side, for example. Between the anode separator 3 and the membrane electrode assembly of the UEA 2, an anode flow path PAa (see FIG. 3) through which fuel gas (anode gas) flows is formed. The separator 3 on the rear side of the UEA 2 is a separator (cathode separator) on a cathode side, for example. Between the cathode separator 3 and the membrane electrode assembly of the UEA 2, a cathode flow path PAc (see FIG. 3) through which oxidant gas (cathode gas) flows is formed. The fuel gas is a gas containing hydrogen, and hydrogen gas can be used, for example. The oxidant gas is a gas containing oxygen, and air can be used, for example. The fuel gas and the oxidant gas may collectively be referred to as a reaction gas without distinguishing between them.

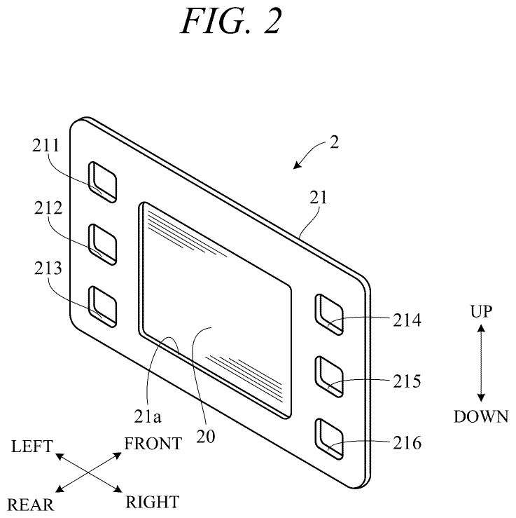

FIG. 2 is a perspective view showing a schematic configuration of the UEA 2. As shown in FIG. 2, the UEA 2 includes a substantially rectangular membrane electrode assembly (hereinafter, referred to as a “MEA”) 20 and a frame 21 that supports the MEA 20. The MEA 20 has an electrolyte membrane, an anode electrode provided on a front surface of the electrolyte membrane, and a cathode electrode provided on a rear surface of the electrolyte membrane.

The electrolyte membrane is, for example, a solid polymer electrolyte membrane, and a thin film of perfluorosulfonic acid polymer containing moisture can be used. Not only a fluorine-based electrolyte but also a hydrocarbon-based electrolyte can be used.

The anode electrode has an electrode catalyst layer formed on the front surface of the electrolyte membrane and served as a reaction field for electrode reaction, and a gas diffusion layer formed on the front surface of the electrode catalyst layer to spread and supply the fuel gas. The cathode electrode has an electrode catalyst layer formed on the rear surface of the electrolyte membrane and served as a reaction field for electrode reaction, and a gas diffusion layer formed on the rear surface of the electrode catalyst layer to spread and supply the oxidant gas. The electrode catalyst layers include a catalyst metal that promotes the electrochemical reaction of hydrogen contained in the fuel gas and oxygen contained in the oxidant gas, an electrolyte (such as an ionomer) with proton conductivity, and carbon particles with electron conductivity, and the like. The gas diffusion layers are made of conductive members with gas permeability, such as carbon porous bodies.

In the anode electrode, the fuel gas (hydrogen) supplied through the anode flow path PAa is ionized by an action of a catalyst, passes through the electrolyte membrane, and moves to the cathode electrode side. Electrons generated at this time pass through an external circuit and are extracted as electric energy. In the cathode electrode, an oxidant gas (oxygen) supplied via the cathode flow path PAc reacts with hydrogen ions guided from the anode electrode and electrons moved from the anode electrode to generate water. The generated water gives an appropriate humidity to the electrolyte membrane, and excess water is discharged to an outside of the UEA 2 along the gas flow. The generated water on the cathode side also flows to the anode side by inverse spread through the electrolyte membrane. Therefore, the generated water is present in both the anode flow path PAa and the cathode flow path PAc.

The frame 21 is a thin plate having a substantially rectangular shape, and is made of an insulating resin, rubber, or the like. A substantially rectangular opening 21a is provided in a central portion of the frame 21. The MEA 20 is disposed to cover the entire opening 21a and a peripheral portion of the MEA 20 is supported by the frame 21. Three through-holes 211 to 213 penetrating the frame 21 in the front-rear direction are opened side by side in the up-down direction on the left side of the opening 21a of the frame 21. Three through-holes 214 to 216 penetrating the frame 21 in the front-rear direction are opened side by side in the up-down direction on the right side of the opening 21a of the frame 21. For convenience, the through-holes 211 to 216 are all shown as having a substantially rectangular shape, but the shape and arrangement of the through-holes 211 to 216 are not limited to this.

As shown in FIG. 1, in the separator 3 in front of and behind the UEA 2, through-holes 311 to 316 penetrating the separators 3 in the front-rear direction are opened at positions corresponding to the through-holes 211 to 216 of the frame 21. The through-holes 311 to 316 communicate with the through-holes 211 to 216 of the frame 21, respectively. The set of the through-holes 211 to 216 and 311 to 316 communicating with each other forms flow paths PA1 to PA6 (indicated by arrows for the sake of convenience) penetrating the cell stacked body 101 and extending in the front-rear direction. The flow paths PA1 to PA6 may be referred to as manifolds. The flow paths PA1 to PA6 are connected to a manifold outside the fuel cell stack 100.

The flow path PA1 (solid arrow) extending forward via the through-holes 211 and 311 is a fuel gas supply flow path. The flow path PA6 (solid arrow) extending rearward via the through-holes 216 and 316 is a fuel gas discharge flow path. The fuel gas supply flow path PA1 and the fuel gas discharge flow path PA6 communicate with the anode flow path facing the front surface of the MEA 20, and as indicated by the solid arrows, the fuel gas (anode gas) flows through the anode flow path from the left (upper left) to the right (lower right) via the fuel gas supply flow path PA1 and the fuel gas discharge flow path PA6. The communication between the anode flow path and the other flow paths PA2 to PA5 is blocked via a seal portion not shown. The fuel gas flowing through the fuel gas discharge flow path PA6 is the fuel gas after being partially used in the anode electrode, and this is sometimes called fuel exhaust gas (anode off-gas).

The flow path PA4 (dotted arrow) extending forward via the through-holes 214 and 314 is an oxidant gas supply flow path. The flow path PA3 (dotted arrow) extending rearward via the through-holes 213 and 313 is an oxidant gas discharge flow path. The oxidant gas supply flow path PA4 and the oxidant gas discharge flow path PA3 communicate with the cathode flow path facing the rear surface of the MEA 20, and as indicated by the dotted arrows, the oxidant gas flows through the cathode flow path from the right (upper right) to the left (lower left) via the oxidant gas supply flow path PA4 and the oxidant gas discharge flow path PA3. The communication between the cathode flow path and the other flow paths PA1, PA2, PA5 and PA6 is blocked via a seal portion not shown. The oxidant gas flowing through the oxidant gas discharge flow path PA3 is the oxidant gas after being partially used in the cathode electrode, and this is sometimes called oxidant exhaust gas (cathode off-gas). Without distinguishing between the fuel exhaust gas and the oxidant exhaust gas, these are sometimes collectively referred to as reaction exhaust gas.

The flow path PA5 (dashed-dotted arrow) extending forward via the through-holes 215 and 315 is a cooling medium supply flow path. The flow path PA2 (dashed-dotted arrow) extending rearward via the through-holes 212 and 312 is a cooling medium discharge flow path. The cooling medium supply flow path PA5 and the cooling medium discharge flow path PA2 communicate with the cooling flow path inside the separator 3, and the cooling medium flows through the cooling flow path via the cooling medium supply flow path PAS and the cooling medium discharge flow path PA2. The communication between the cooling flow path and the other flow paths PA1, PA3, PA4 and PA6 is blocked via a seal portion not shown.

Each of the end units 102 disposed on both sides in the front-rear direction of the cell stacked body 101 includes a terminal plate 4, an insulating plate 5, and an end plate 6. The front end unit 102 is sometimes called a dry side end unit, and the rear end unit 102 is sometimes called a wet side end unit. The pair of terminal plates 4 and 4 are arranged on both sides in the front-rear direction sandwiching the cell stacked body 101. The pair of insulating plates 5 and 5 are arranged on both sides in the front-rear direction sandwiching the terminal plates 4 and 4. The pair of end plates 6 and 6 are arranged on both sides in the front-rear direction sandwiching the insulating plates 5 and 5.

The terminal plate 4 is a substantially rectangular plate-shaped member made of metal, and has a terminal portion for extracting electric power generated by an electrochemical reaction in the cell stacked body 101. The insulating plate 5 is a substantially rectangular plate-shaped member made of non-conductive resin or rubber, and electrically insulates the terminal plate 4 from the end plate 6. The end plate 6 is a plate-shaped member made of metal or resin having high strength. The pair of front and rear end plates 6 and 6 are fixed by bolts to the front and rear ends of a case surrounding the cell stacked body 101, for example, with a predetermined compressive load applied in the front-rear direction. The fuel cell stack 100 is held in a state of being pressed in the front-rear direction via the case.

A plurality of through-holes 102a to 102f that penetrate the end unit 102 in the front-rear direction are opened in the rear end unit 102. Although the through-holes 102a to 102f each includes a through-hole penetrating the terminal plate 4, a through-hole penetrating the insulating plate 5, and a through-hole penetrating the end plate 6, but in FIG. 1, these are collectively shown as through-holes 102a to 102f for convenience. The through-hole 102a is opened on the extension line of the fuel gas supply flow path PA1 so as to communicate with the fuel gas supply flow path PA1. The through-hole 102b is opened on the extension line of the cooling medium discharge flow path PA2 so as to communicate with the cooling medium discharge flow path PA2. The through-hole 102c is opened on the extension line of the oxidant gas discharge flow path PA3 so as to communicate with the oxidant gas discharge flow path PA3. The through-hole 102d is opened on the extension line of the oxidant gas supply flow path PA4 so as to communicate with the oxidant gas supply flow path PA4. The through-hole 102e is opened on the extension line of the cooling medium supply flow path PA5 so as to communicate with the cooling medium supply flow path PA5. The through-hole 102f is opened on the extension line of the fuel gas discharge flow path PA6 so as to communicate with the fuel gas discharge flow path PA6.

More specifically, a fuel gas tank storing high-pressure fuel gas is connected to the through-hole 102a via an ejector, an injector, etc., and the fuel gas in the fuel gas tank is supplied to the fuel cell stack 100 through the through-hole 102a. A gas-liquid separator is connected to the through-hole 102f, and the fuel gas (fuel exhaust gas) discharged through the through-hole 102f is separated into fuel gas and water by the gas-liquid separator. The separated fuel gas is drawn in through an ejector and resupplied to the fuel cell stack 100 via the through-hole 102a. The separated water is discharged to the outside through a drain flow path.

A compressor for supplying oxidant gas is connected to the through-hole 102d, and the oxidant gas compressed by the compressor is supplied to the fuel cell stack 100 through the through-hole 102d. The oxidant gas (oxidant exhaust gas) is discharged from the through-hole 102c. A pump for supplying cooling medium is connected to the through-hole 102e, and the cooling medium is supplied to the fuel cell stack 100 through the through-hole 102e. The cooling medium is discharged from the through-hole 102b. The discharged cooling medium is cooled by heat exchange in the radiator, and is supplied again to the fuel cell stack 100 through the through-hole 102e.

The above is the schematic configuration of the fuel cell stack 100. The fuel cell stack 100 is housed in a substantially box-shaped case and mounted on a vehicle.

Incidentally, in the anode electrode, generated water is generated by diffusion from the cathode electrode side through the electrolyte membrane. The generated water flows to the fuel gas discharge flow path PA6 through the anode flow path and is discharged together with the fuel exhaust gas, but when the fuel gas is recirculated, the generated water may flow into the fuel gas supply flow path PA1 together with the fuel gas. Condensed water is generated inside the fuel cell stack 100 or in the pipe constituting the external manifold, and this condensed water may also flow into the fuel gas supply flow path PA1 together with the fuel gas. Hereinafter, the generated water and the condensed water are collectively referred to as liquid water. The liquid water flows into not only the fuel gas supply flow path PA1 but also the oxidant gas supply flow path PA4.

When the liquid water flows into the supply flow paths (gas supply flow paths) PA1 and PA4 of the reaction gas as described above, the liquid water is guided to the power generation surface of the power generation cell 1, so that power generation may become unstable, and there is a possibility that a power generation performance is deteriorated. In order to avoid such inflow of the liquid water, when a stirring mixer or the like is arranged in the external manifold upstream of the gas supply flow paths PA1 and PA4, a pressure loss increases, and it becomes difficult to obtain desired power generation performance. In this regard, in order to suppress the deterioration in power generation performance due to the liquid water having flowed in from the gas supply flow paths PA1 and PA4, in the present embodiment, the fuel cell stack 100 is configured as follows.

The configurations of the fuel gas supply flow path PA1 and the oxidant gas supply flow path PA4 are substantially the same. Therefore, hereinafter, the configurations of the gas supply flow paths PA1 and PA4 will be described focusing on the fuel gas supply flow path PA1. FIG. 3 is a cross-sectional view illustrating a configuration of a main part of the fuel cell stack 100 along the fuel gas supply flow path PA1.

In FIG. 3, in order to distinguish the configurations of front and rear end units 102, the front end unit 102 is represented by a terminal plate 40, an insulating plate 50, and an end plate 60, and the rear end unit 102 is represented by a terminal plate 41, an insulating plate 51, and an end plate 61. As illustrated in FIG. 3, the fuel gas supply flow path PA1 extends in the front-rear direction through the through-hole 102a of the rear end unit 102, through-holes 211 and 311 of the cell stacked body 101, and the through-hole 102a of the front end unit 102. Therefore, the end unit 102 and the cell stacked body 101 are provided with a flow path forming portion forming the fuel gas supply flow path PA1.

The through-hole 102a of the front end unit 102 includes the through-hole 40a of the terminal plate 40 and the through-hole 50a of the insulating plate 50. The front end of the fuel gas supply flow path PA1 is closed by the end plate 60. The through-hole 102a of the rear end unit 102 includes the through-hole 41a of the terminal plate 41, the through-hole 51a of the insulating plate 51, and the through-hole 61a of the end plate 61.

The cell stacked body 101 includes a plurality of power generation cells 1 that are power generation elements and a dummy cell 1d that is a non-power generation element. The dummy cell 1d is interposed between the rearmost power generation cell 1 and the rear terminal plate 41 and between the foremost power generation cell 1 and the front terminal plate 40. More specifically, two sets of dummy cells 1d are interposed between the power generation cell 1 and each of the terminal plates 40 and 41.

The dummy cell 1d includes a pair of front and rear separators 3 having the same configuration as that of the power generation cell 1, and a dummy assembly 2d interposed between the separators 3 and 3. The dummy assembly 2d includes a frame 21 having the same configuration as that of the power generation cell 1 and a dummy joint 20d. That is, the dummy cell 1d is different from the power generation cell 1 in that the dummy cell 1d has the dummy joint 20d instead of the MEA 20.

The dummy joint 20d is a joint of a conductive plate and an electrode, provided so as to cover the opening 21a (FIG. 2) of the frame 21. Therefore, the dummy cell 1d does not have the electrolyte membrane, and power generation is not performed in the dummy cell 1d. By arranging the dummy cells 1d adjacent to both ends in the front-rear direction of the power generation cell 1 in this manner, the dummy cells 1d function as heat insulating layers, and a decrease in temperature of the power generation cell 1 can be suppressed. In FIG. 3, two sets of dummy cells 1d are arranged between the power generation cell 1 and each of the terminal plates 40 and 41, but one set or three or more sets of dummy cells 1d may be arranged. One or both of the dummy cells 1d on the front side and the rear side can be omitted.

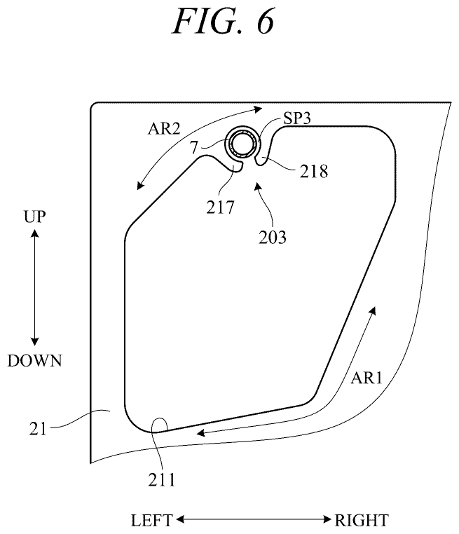

In the fuel gas supply flow path PA1, a communication tube 7 is installed along the flow path PA1 on upper surface of the flow path PA1. Although not illustrated in detail, around the through-hole 311 of the separator 3 constituting the flow path PA1, a communication flow path 3b that communicates the flow path PA1 and the anode flow path PAa is provided in a region (a region AR1 in FIG. 6) from the lower surface to the right surface on the opening surface of the through-hole 311. The communication tube 7 is installed in a region (the upper surface), which is different from the region (from the lower surface to the right surface) provided with the communication flow path 3b, of the inner wall surface (inner peripheral surface) of the flow path PA1. The communication flow path 3b is configured by, for example, a tunnel portion crossing a rib-shaped seal portion (metal bead seal 3c) in the up-down direction.

The communication tube 7 is an elongated tube member having a substantially ring-shaped cross section in which an opening (front end opening 71a, rear end opening 72a) is provided in each of the front end portion 71 and the rear end portion 72, and linearly extends in the front-rear direction through the cell stacked body 101. The front end opening 71a of the communication tube 7 is located inside an internal space SP1 of the through-hole 102a of the front end unit 102, more specifically, inside the through-hole 50a of the insulating plate 50. The rear end opening 72a of the communication tube 7 is located inside an internal space SP2 of the through-hole 102a of the rear end unit 102, more specifically, inside the through-hole 51a of the insulating plate 51. Therefore, the internal space SP1 of the front end unit 102 and the internal space SP2 of the rear end unit 102 communicate with each other through the communication tube 7.

The communication tube 7 is made of resin, rubber, glass, or the like as a component material. However, considering that vibration and temperature change occurs in the fuel cell stack 100, the communication tube 7 is preferably made of flexible resin or rubber. A pressure in the internal space SP2 on the upstream side of the fuel gas supply flow path PA1 is higher than a pressure in the internal space SP1 on the downstream side. In the communication tube 7, water flows from the rear end opening 72a to the front end opening 71a according to a pressure difference between the internal spaces SP1 and SP2. Therefore, although a cross-sectional area of the communication tube 7 is sufficiently smaller than a cross-sectional area of the fuel gas supply flow path PA1, the cross-sectional area is set so as to enable a flow of a predetermined amount or more of water. In other words, the communication tube 7 forms, in the flow path PA1, a constricted region having a cross-sectional area significantly smaller than that of the flow path PA1.

The front end portion of the communication tube 7 is supported by a front support portion 201 provided in the front end unit 102. The rear end portion of the communication tube 7 is supported by a rear support portion 202 provided in the rear end unit 102.

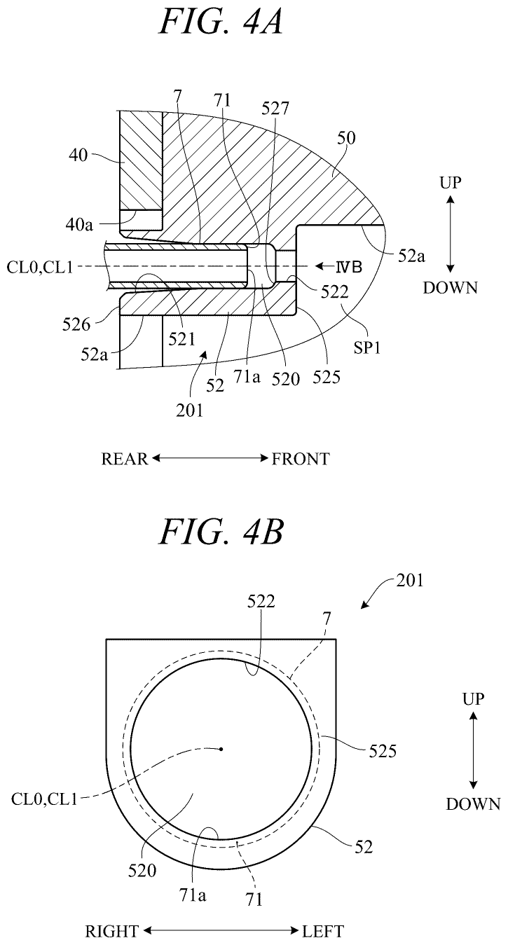

FIG. 4A is an enlarged view of a main part of FIG. 3 illustrating a configuration of the front support portion 201, and FIG. 4B is a view taken along an arrow IVB in FIG. 4A (viewed from the front). As illustrated in FIGS. 4A and 4B, a bulge 52 bulging downward is provided on an upper surface of the through-hole 50a of the insulating plate 50 at an intermediate portion in the front-rear direction from a rear end portion thereof. In FIG. 4A, the bulge 52 has a protrusion 52a protruding rearward, and the protrusion 52a is located inside the through-hole 40a of the terminal plate 40. Thus, the insulating plate 50 is partially elongated in the front-rear direction, and the front end portion of the communication tube 7 is supported by the elongated portion.

A through-hole 520 having a circular cross section around an axis CL0 extending in the front-rear direction is opened in the bulge 52 from the front end surface 525 to a rear end surface 526. The through-hole 520 includes a tapered portion 521 on a rear side of a boundary surface 527 and a straight portion 522 on a front side of the boundary surface 527 with the boundary surface 527 extending in the up-down direction perpendicular to the axis CL0 as a boundary. The tapered portion 521 is formed in a tapered shape such that a cross-sectional area gradually decreases from the rear end surface 526 of the bulge 52 to the boundary surface 527. That is, the tapered portion 521 is formed to have a space of a truncated cone inside. The straight portion 522 is formed linearly with a constant or substantially constant cross-sectional area from the front end surface 525 to the boundary surface 527 of the bulge 52. A cross-sectional area of the straight portion 522 is smaller than a cross-sectional area of the front end of the tapered portion 521. An angle formed by the tapered portion 521 with respect to the axis CL0 is about several degrees (for example, 2 to 3° to 4 to 5°), and a length of the tapered portion 521 in the front-rear direction is longer than a length of the straight portion 522 in the front-rear direction.

A diameter of an outer peripheral surface of the communication tube 7 is larger than a diameter of the front end surface (boundary surface 527) of the tapered portion 521 and smaller than a diameter of the rear end surface 526 of the tapered portion 521. A diameter of an inner peripheral surface of the communication tube 7 is the same as a diameter of the straight portion 522 or smaller than the diameter of the straight portion 522. As a result, when the communication tube 7 is inserted into the through-hole 520 from the rear of the bulge 52, an outer peripheral corner of the front end of the communication tube 7 abuts on a peripheral surface of the tapered portion 521, and a center line CL1 of the communication tube 7 coincides with the axis CL0. As a result, the front end portion of the communication tube 7 can be supported from the insulating plate 50 while the front end portion of the communication tube 7 is positioned by the tapered portion 521. Since a movement of the communication tube 7 is restricted by the tapered portion 521, positional displacement of the communication tube 7 can be prevented. In a state where the communication tube 7 is supported by the front support portion 201, the front end opening 71a of the communication tube 7 communicates with the internal space SP1 of the end unit 102, more specifically, the internal space SP1 in front of the bulge 52 through the through-hole 520.

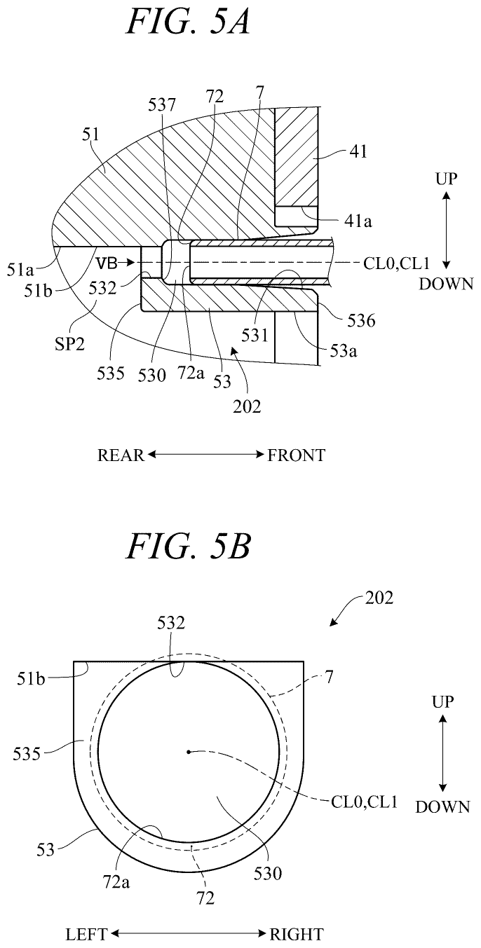

FIG. 5A is an enlarged view of a main part of FIG. 3 illustrating a configuration of the rear support portion 202, and FIG. 5B is a view taken along an arrow VB in FIG. 5A (viewed from the rear). As illustrated in FIGS. 5A and 5B, a bulge 53 bulging downward is provided on an upper surface of the through-hole 51a of the insulating plate 51 at an intermediate portion in the front-rear direction from a front end portion thereof. In FIG. 5A, the bulge 53 has a protrusion 53a protruding frontward, and the protrusion 53a is located inside the through-hole 41a of the terminal plate 41. Thus, the insulating plate 51 is partially elongated in the front-rear direction, and the rear end portion of the communication tube 7 is supported by the elongated portion.

A through-hole 530 having a circular cross section around an axis CL0 extending in the front-rear direction is opened in the bulge 53 from the rear end surface 535 to a front end surface 536. The through-hole 530 includes a tapered portion 531 on a front side of a boundary surface 537 and a straight portion 532 on a rear side of the boundary surface 537 with the boundary surface 537 extending in the up-down direction perpendicular to the axis CL0 as a boundary. The tapered portion 531 is formed in a tapered shape such that a cross-sectional area gradually decreases from the front end surface 536 of the bulge 53 to the boundary surface 537. That is, the tapered portion 531 is formed to have a space of a truncated cone inside. The straight portion 532 is formed linearly with a constant or substantially constant cross-sectional area from the rear end surface 535 to the boundary surface 537 of the bulge 53. A cross-sectional area of the straight portion 532 is smaller than a cross-sectional area of the rear end of the tapered portion 531. An angle formed by the tapered portion 531 with respect to the axis CL0 is about several degrees (for example, 2 to 3° to 4 to 5°), and a length of the tapered portion 531 in the front-rear direction is longer than a length of the straight portion 532 in the front-rear direction.

A diameter of an outer peripheral surface of the communication tube 7 is larger than a diameter of the rear end surface (boundary surface 537) of the tapered portion 531 and smaller than a diameter of the front end surface 536 of the tapered portion 531. A diameter of an inner peripheral surface of the communication tube 7 is the same as a diameter of the straight portion 532 or smaller than the diameter of the straight portion 532. As a result, when the communication tube 7 is inserted into the through-hole 530 from the front of the bulge 53, an outer peripheral corner of the rear end of the communication tube 7 abuts on a peripheral surface of the tapered portion 531, and a center line CL1 of the communication tube 7 coincides with the axis CL0. As a result, the rear end portion of the communication tube 7 can be supported from the insulating plate 50 while the rear end portion of the communication tube 7 is positioned by the tapered portion 531. Since a movement of the communication tube 7 is restricted by the tapered portion 531, positional displacement of the communication tube 7 can be prevented. In a state where the communication tube 7 is supported by the rear support portion 202, the rear end opening 72a of the communication tube 7 communicates with the internal space SP2 of the end unit 102, more specifically, the internal space SP2 behind the bulge 53 through the through-hole 530.

In addition to the communication tube 7 being supported by the support portions 201 and 202 of the front and rear end units 102, the communication tube 7 may also be supported by the frame 21 of the UEA 2 included in the cell stacked body 101. That is, an intermediate support portion that supports the intermediate portion of the communication tube 7 in the front-rear direction may be provided. FIG. 6 is a front view (view from the rear) illustrating the configuration of the through-hole 211 (FIG. 2) of the fuel gas supply frame 21 provided with the intermediate support portion 203. As illustrated in FIG. 6, a pair of left and right protrusions 217 and 218 protruding downward is provided on an upper surface of the through-hole 211 of the frame 21. The protrusions 217 and 218 are formed in a substantially arc shape so as to form a substantially cylindrical space SP3 along the upper surface of the through-hole 211.

The communication tube 7 is inserted into the space SP3 from the front or the rear of the cell stacked body 101. A diameter of the space SP3 is slightly larger than an outer diameter of the communication tube 7 so that the communication tube 7 can be easily inserted. As a result, an intermediate portion of the communication tube 7 in the front-rear direction is positioned by the protrusions 217 and 218, and the communication tube 7 can be stably supported. However, since both ends of the communication tube 7 in the front-rear direction are positioned by the tapered portions 521 and 531, the protrusions 217 and 218 are provided so as to perform gentle positioning to the extent that the positioning by the tapered portions 521 and 531 is not impaired. Therefore, it is not necessary to increase accuracy of the protrusions 217 and 218 so much.

The protrusions 217 and 218 configure an intermediate support portion 203 that supports an intermediate portion of the communication tube 7. The intermediate support portion 203 may be provided in all the frames 21 included in the cell stacked body 101, or may be provided in a part of the frames 21. The intermediate support portion 203 may be formed by connecting the distal end portions of the protrusions 217 and 218 to each other to provide a single protrusion and providing an opening having a substantially circular shape in a front view in the protrusion. Although depending on a material of the communication tube 7, when rigidity of the communication tube 7 is high and the communication tube 7 can be firmly supported by the front support portion 201 and the rear support portion 202, the intermediate support portion 203 may be omitted. The front support portion 201 and the rear support portion 202 may be configured to restrict only the position of the communication tube 7 in the front-rear direction, and the intermediate support portion 203 may restrict a position in the up-down direction and the left-right direction of the communication tube 7.

As illustrated in FIGS. 3 and 5A, a peripheral surface of the through-hole 51a of the insulating plate 51, particularly, an uppermost portion of the inner peripheral surface is formed as a flat surface 51b that is flat in the front-rear direction. The uppermost portion of the inner peripheral surface of the straight portion 532 is positioned on the extension surface obtained by extending the flat surface 51b forward, and the peripheral surface of the through-hole 51a is connected to the inner peripheral surface of the straight portion 532 without a step.

As illustrated in FIG. 3, an upper end portion 81 of a substantially L-shaped pipe 8 is attached to the rear end plate 61 so as to communicate with the through-hole 61a. The pipe 8 extends downward through a bent portion 8a, and a lower end portion 82 of the pipe 8 opens downward. For example, an ejector is connected to the lower end portion 82 of the pipe 8. In the pipe 8, an external flow path PA15 having an opening surface 82a at a lower end is formed, and a fuel gas is supplied into the pipe 8 from below as indicated by an arrow. The supplied fuel gas flows upward, collides with the inner peripheral surface of the upper end portion (bent portion 8a) of the pipe 8, then changes the flow direction forward, and flows into the fuel gas supply flow path PA1 inside the cell stacked body 101.

The front insulating plate 50 is provided with a communication hole 55 that communicates the fuel gas supply flow path PA1 and the fuel gas discharge flow path PA6 (FIG. 1). An opening 55a of the communication hole 55 on the fuel gas supply flow path PA1 side is located on the bottom surface of the through-hole 50a. The opening 55a is provided at the same position or substantially the same position in the front-rear direction as that of the front end surface 525 (FIG. 4A) of the bulge 52, or in front of the front end surface 525. The communication hole 55 forms a drain passage PA10 that guides liquid water to the fuel gas discharge flow path PA6.

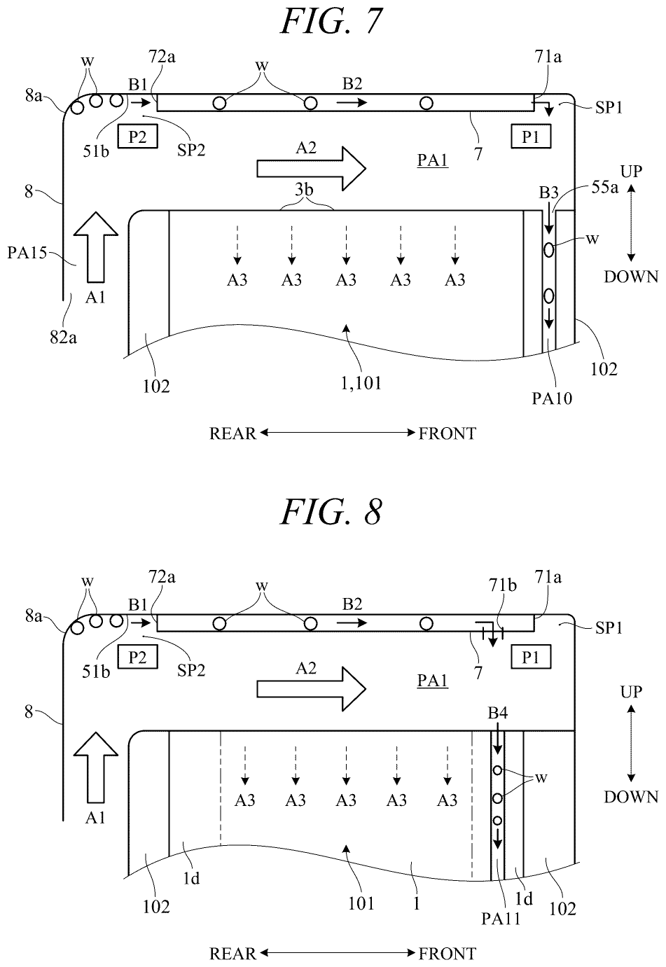

A main operation of the fuel cell stack 100 configured as described above will be described. FIG. 7 is a view schematically illustrating flows of the fuel gas and the liquid water in the fuel gas supply flow path PA1. Although not illustrated, the fuel gas supply flow path PA1 and the oxidant gas supply flow path PA4 have substantially the same configuration, and thus the flows of the oxidant gas and the liquid water in the oxidant gas supply flow path PA4 are also similar to those in FIG. 7. As indicated by an arrow A1 in FIG. 7, the fuel gas having flowed into the pipe 8 through the opening surface 82a to flow through the external flow path PA15 from below to above changes the flow direction rightward and flows into the fuel gas supply flow path PA1.

In the fuel gas supply flow path PA1, the fuel gas is dispersed while flowing forward as indicated by an arrow A2, and flows to the anode flow path PAa (FIG. 3) facing the power generation surface of the power generation cell 1 through the communication flow path 3b as indicated by an arrow A3. As a result, power is generated in the power generation cell 1. Due to such a flow of the fuel gas, the inner pressure of the flow path PA1 gradually decreases toward the front. Therefore, in the fuel gas supply flow path PA1, a pressure P2 of the internal space SP2 in the vicinity of the rear end opening 72a of the communication tube 7 is the maximum, a pressure P1 of the internal space SP1 in the vicinity of the front end opening 71a of the communication tube 7 is the minimum, and a pressure difference (P2−P1) between the internal spaces SP1 and SP2 is relatively large.

Since the pipe 8 has the bent portion 8a in the vicinity of the attachment portion to the end unit 102, the fuel gas containing the liquid water (mainly generated water) collides with the inner peripheral surface of the pipe 8 in the vicinity of the bent portion 8a, and liquid water “w” easily adheres to the inner peripheral surface (upper surface) in the vicinity of the bent portion 8a. Since the outer surface of the bent portion 8a faces the atmosphere and a temperature easily decreases, the liquid water (condensed water in this case) easily adheres also in this point. The liquid water “w” adhering to the inner peripheral surface of the bent portion 8a moves forward together with the flow of the fuel gas as indicated by an arrow B1, and further moves forward in the communication tube 7 due to the pressure difference between the internal spaces SP1 and SP2 as indicated by an arrow B2. At this time, the liquid water “w” flows toward the communication tube 7 along the flat surface 51b of the upper surface of the through-hole 51a. Therefore, the liquid water “w” can be easily guided to the inside of the communication tube 7.

The liquid water “w” having flowed through the communication tube 7 flows out from the front end opening 71a of the communication tube 7, and then flows into the drain passage PA10 through the opening 55a below the front end opening 71a as indicated by an arrow B3. Further, the liquid water “w” flows into fuel gas discharge flow path PA6 through the drain passage PA10, and is discharged from fuel cell stack 100 together with the flow of the fuel exhaust gas. As a result, the liquid water “w” in the gas supply flow paths PA1 and PA4 can be suppressed from being guided to the power generation surface, and a stable power generation performance can be obtained.

Although the drain passage PA10 is provided in the front end unit 102 in the above description, a drain passage may be provided in a region other than the end unit 102 as long as the region is a region (non-power generation region) different from a power generation region in which the power generation cell 1 is installed. For example, a drain passage can be provided in the front dummy cell 1d. FIG. 8 is a view schematically illustrating flows of the fuel gas and the liquid water in the fuel gas supply flow path PA1 in that case, and is a view illustrating a modification of FIG. 7. Although not illustrated, the oxidant gas supply flow path PA4 is configured similarly to the fuel gas supply flow path PA1.

As illustrated in FIG. 8, the front dummy cell 1d is provided with a drain passage PA11 that communicates the fuel gas supply flow path PA and the fuel gas discharge flow path PA6. The drain passage PA11 is configured by a gas flow path (corresponding to the anode flow path of the power generation cell 1) provided between the dummy assembly 2d and the separator 3 of the dummy cell 1d. Therefore, the drain passage PA11 can be configured without performing new processing on the dummy cell 1d.

On the bottom surface of the communication tube 7, an opening 71b is provided at the same position in the front-rear direction as that of the front dummy cell 1d. At this time, the front end opening 71a of the communication tube 7 is closed. As a result, the liquid water “w” flows through the inside of the communication tube 7 according to the pressure difference between the internal space SP1 and a space in the flow path PA1 in the vicinity of the opening 71b (a space in the vicinity of the internal space SP1), and the liquid water “w” flows out from the opening 71b. As indicated by an arrow B4, the liquid water “w” further flows through the drain passage PA11, is guided to the fuel gas discharge flow path PA6, and is discharged from the fuel cell stack 100. The opening 71b of the communication tube 7 may be provided in front of the dummy cell 1d. The opening 71b may not be provided in the bottom surface of the communication tube 7, and the front end opening 71a may be opened to allow the liquid water “w” to flow out from the front end opening 71a, and guide the flowed liquid water “w” to the drain passage PA11 of the dummy cell 1d.

According to the present embodiment, the following operations and effects are achievable.

(1) The fuel cell stack 100 includes: a cell stacked body 101 having a plurality of power generation cells 1 stacked in the front-rear direction, in which gas supply flow paths PA1 and PA4 into which a reaction gas is supplied, gas discharge flow paths PA3 and PA6 from which the reaction gas is discharged each extend along the front-rear direction, and a gas flow path (anode flow path, cathode flow path) which communicates the gas supply flow paths PA1 and PA4 and the gas discharge flow paths PA3 and PA6 are provided; a rear end unit 102 which is arranged on a rear end side of the cell stacked body 101 and provided with through-holes 102a and 102d (supply ports) which communicate with the gas supply flow paths PA1 and PA4 and through-holes 102c and 102f (discharge ports) which communicate with the gas discharge flow paths PA3 and PA6; a front end unit 102 which is arranged on a front end side of the cell stacked body 101; and a communication tube 7 which is arranged in the gas supply flow paths PA1 and PA4 and extends in the front-rear direction and in which a rear end opening 72a and a front end opening 71a which communicate with the internal space SP2 on an upstream side and the internal space SP1 on a downstream side of the gas supply flow paths PA1 and PA4 are provided in a front end portion and a rear end portion, respectively (FIGS. 1 to 3). In the non-power generation region in front of the power generation region of the cell stacked body 101 in which the plurality of power generation cells 1 are arranged, the drain passages PA10 and PA11 which guide, to the gas discharge flow paths PA3 and PA6, the liquid water having flowed out from the front end opening 71a are provided (FIGS. 3 and 8).

With this configuration, the liquid water having flowed into the gas supply flow paths PA1 and PA4 is guided to the downstream side of the flow paths PA1 and PA4 beyond the power generation cell 1 through the communication tube 7, and thus it is possible to suppress the liquid water from flowing from the flow paths PA1 and PA4 to the power generation surface. That is, the liquid water having flowed into the gas supply flow paths PA1 and PA4 flows into the gas discharge flow paths PA3 and PA6 without passing through the anode flow path and the cathode flow path. As a result, a stable power generation performance can be obtained, and deterioration in the power generation performance can be suppressed. In addition, it is not necessary to arrange a stirring mixer or the like on the upstream side of the flow paths PA1 and PA4, so that it is possible to suppress an increase in cost, suppress a pressure loss in the flow path, and realize a smooth flow of the reaction gas. That is, it is possible to satisfactorily discharge the liquid water “w”ithout passing through the power generation cell 1 while ensuring a smooth flow of the reaction gas.

(2) The drain passage PA10 is provided in the front end unit 102 (FIGS. 3 and 7). As a result, a distance in the front-rear direction from the power generation cell 1 to the drain passage PA10 can be increased, and the liquid water can be satisfactorily suppressed from being mixed into the power generation cell 1. In addition, the pressure difference between the front and rear of the communication tube 7 increases, and the liquid water easily flows through the inside of the communication tube 7.

(3) The cell stacked body 101 includes the dummy cell 1d, which is a non-power generation element, between the plurality of power generation cells 1 and the front end unit 102 (FIG. 3). The drain passage PA11 is provided in the dummy cell 1d (FIG. 8). As a result, it is not necessary to form the drain passage PA10 in the end unit 102, so that the fuel cell stack 100 can be constructed at low cost.

(4) The communication tube 7 is provided so as to form a constricted region in a part of the gas supply flow paths PA1 and PA4 (FIGS. 3 and 6). As a result, the part of the gas supply flow paths PA1 and PA4 is used as a flow path for liquid water. Therefore, the configuration of the fuel cell stack 100 is easy as compared with a case where a passage through which liquid water flows is provided in a space different from the gas supply flow paths PA1 and PA4.

(5) The communication flow paths 3b communicating with the anode flow path PAa and the cathode flow path PAc are provided in predetermined regions AR1 (a first region) in the circumferential direction of the flow path inner wall surface along the front-rear direction of the cell stacked body 101 in which the gas supply flow paths PA1 and PA4 are formed, that is, in a region from the right surface to the lower surface in the fuel gas supply flow path PA1 and a region from the left surface to the lower surface in the oxidant gas supply flow path PA4, respectively (FIG. 3). The communication tube 7 is arranged in a region AR2 (a second region) different from the region AR1 in which the communication flow path 3b is provided, that is, on the upper surface of the flow path inner wall surface (FIG. 6). As a result, it is possible to prevent the gas flow passing through the communication flow path 3b from being obstructed by providing the communication tube 7.

(6) The pipe 8 is further provided in which the external flow path PA15 communicating with one of the gas supply flow paths PA1 and PA4 is formed from the lower end portion 82 to the upper end portion 81, and the upper end portion 81 is connected to the end unit 102 to communicate with the through-holes 102a and 102d of the rear end unit 102 (FIG. 3). The pipe 8 is configured such that the opening surface 82a is provided in the lower end portion 82 so as to face downward (FIG. 3). When the reaction gas is supplied through such a pipe 8, the reaction gas collides with the inner peripheral surface of the bent portion 8a of the pipe 8, and liquid water easily adheres to the vicinity of the bent portion 8a. In the present embodiment, the communication tube 7 is arranged so as to be connected to the bent portion 8a, so that liquid water can be easily guided to the communication tube 7, and drainage performance for discharging liquid water from the flow paths PA1 and PA4 is improved.

(7) The peripheral surfaces of the through-holes 102a and 102d of the rear end unit 102 has the flat surfaces 51b extending flatly in the front-rear direction toward the rear end opening 72a of the communication tube 7 (FIG. 3). As a result, the liquid water is smoothly guided to the communication tube 7 along the flat surface 51b, and the drainage performance is improved.

(8) The rear end unit 102 has the rear support portion 202 which supports the rear end portion 72 of the communication tube 7, and the front end unit 102 has the front support portion 201 which supports the front end portion 71 of the communication tube 7 (FIG. 3). As a result, the positions of both end portions of the communication tube 7 in the front-rear direction can be restricted to satisfactorily support the communication tube 7.

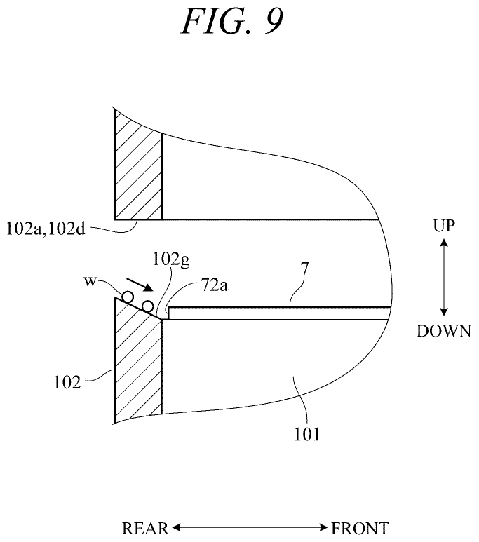

The above embodiment can be modified in various forms. Below, some modified examples are described. In the above embodiment, the communication tubes as a tubular body is arranged on the upper surfaces of the gas supply flow paths PA1 and PA4, but may be arranged on other than the upper surfaces. For example, the communication tube may be arranged on the lower surfaces (bottom surfaces) of the gas supply flow paths PA1 and PA4, or may be arranged on the right surface or the left surface. FIG. 9 is an example, and is a view schematically illustrating an example of installation on the bottom surface of the gas supply flow paths PA1 and PA4. In FIG. 9, each of the peripheral surfaces of the through-holes 102a and 102d of the end unit 102 communicating with the gas supply flow path PA1 and PA4 further has the inclined surface 102g inclined downward toward the front. As a result, the liquid water “w” in the vicinity of the through-hole 102a, 102d flows along the inclined surface 102g and can easily flow into the communication tube 7 through the rear end opening 72a of the communication tube 7. As a result, the flow of liquid water “w” through the communication tube 7 can be promoted.

In the above embodiment, the drain passages PA10 or PA11 is provided in front end unit 102 or the front dummy cell 1d, but as long as the drain passage as a water discharge passage is provided in a non-power generation region on downstream side of a power generation region of the cell stacked body where a plurality of power generation cells are disposed, the configuration of the water discharge passage may be any configuration. In a case that the water discharge passages is provided other than in the dummy cell 1d, the dummy cell 1d may be omitted. In the above embodiment, a plurality of power generation cells 1 are stacked in the front-rear direction (a predetermined direction), with the end unit 102 (a first end unit) placed behind the power generation cell 1 on one side along the predetermined direction, and the end unit 102 (a second end unit) placed in front of the power generation cell 1 on the other side along the predetermined direction, but the stacking direction of the plurality of power generation cells may be other than the front-rear direction. In this case, it is preferable that the stacking direction is substantially horizontal.

In the above embodiment, the communication tube 7 as a tubular body is arranged along the upper surface (a second region) of each of the gas supply flow paths PA1 and PA4, but as long as it is arranged in a region different from the circumferential region (a first region) where each of the communication flow paths 3b of the gas supply flow paths PA1 and PA4 is provided, the communication tube 7 may be arranged in another region. In the above embodiment, the rear end opening 72a as a first opening on the upstream side and the front end opening 71a as a second opening on the downstream side of the gas supply flow paths PA1 and PA4 are provided in the communication tube 7, but the first and second openings may be provided other than at the rear and front ends of the communication tube. In the above embodiment, the rear support portion 202 as a first support portion and the front support portion 201 as a second support portion are used to support both ends of the communication tube 7 in the front-rear direction, but the configuration of the first and second support portions is not limited to the above.

In the above embodiment, the gas supply flow paths PA1 and PA4 are configured to have a constant opening area in the front-rear direction, but the opening area may be varied in the front-rear direction. For example, the opening area of the gas supply flow paths PA1 and PA4 may be configured to achieve a Venturi effect. This allows for an increase in the difference between the pressure P1 of the internal space SP1 facing the front end opening 71a and the pressure P2 of the internal space SP2 facing the rear end opening 72a of the communication tube 7, thereby promoting the flow of liquid water inside the communication tube 7.

The above embodiment can be combined as desired with one or more of the above modifications. The modifications can also be combined with one another.

According to the present invention, it is possible to ensure a smooth flow of a reaction gas while also allowing liquid water to be discharged without passing through the power generation cell.

Above, while the present invention has been described with reference to the preferred embodiments thereof, it will be understood, by those skilled in the art, that various changes and modifications may be made thereto without departing from the scope of the appended claims.

What is claimed is:

1. A fuel cell stack comprising:
a cell stacked body including a plurality of power generation cells stacked in a predetermined direction, a gas supply flow path into which a reaction gas is supplied, a gas discharge flow path through which the reaction gas is discharged, and a gas flow path provided to communicate the gas supply flow path and the gas discharge flow path, the gas supply flow path and the gas discharge flow path being provided to extend in the predetermined direction;
a first end unit disposed on a first side in the predetermined direction of the cell stacked body, a supply port communicating with the gas supply flow path and a discharge port communicating with the gas discharge flow path being provided in the first end unit;
a second end unit disposed on a second side opposite to the first side in the predetermined direction of the cell stacked body; and
a tubular body disposed in the gas supply flow path and extending in the predetermined direction, wherein
the tubular body includes a first end portion and a second end portion opposite to the first end portion,
a first opening is provided at the first end portion of the tubular body so as to communicate with the gas supply flow path on an upstream side in a flow direction of the reaction gas,
a second opening is provided at the second end portion of the tubular body so as to communicate with the gas supply flow path on a downstream side in the flow direction of the reaction gas, and
a water discharge passage is provided in a non-power generation region located on the second side and outside a power generation region of the cell stacked body so as to guide a liquid water flowing out through the second opening to the gas discharge flow path.

2. The fuel cell stack according to claim 1, wherein
the water discharge passage is provided in the second end unit.

3. The fuel cell stack according to claim 1, wherein
the cell stacked body includes a dummy cell disposed between the plurality of power generation cells and the second end unit,
the dummy cell is a non-power generation element while each of the plurality of power generation cells is a power generation element, and
the water discharge passage is provided in the dummy cell.

4. The fuel cell stack according to claim 1, wherein
the tubular body is provided so as to form a constricted region in a part of the gas supply flow path.

5. The fuel cell stack according to claim 1, wherein
a communication flow path communicating with the gas flow path is provided in a first region in a circumferential direction of an inner peripheral surface of the gas supply flow path, and
the tubular body is arranged in a second region different from the first region in the circumferential direction of the inner peripheral surface of the gas supply flow path.

6. The fuel cell stack according to claim 1, further comprising
a pipe member forming an external flow path to communicate with the gas supply flow path from a first end to a second end of the pipe member connected to the first end unit so that the second end communicates with the supply port of the first end unit, wherein
the pipe member is configured so as to form an opening surface facing a direction perpendicular to the predetermined direction at the first end.

7. The fuel cell stack according to claim 1, wherein
an inner circumferential surface of the supply port includes a flat surface extending flatly in the predetermined direction to the first opening of the tubular body.

8. The fuel cell stack according to claim 1, wherein
the first end unit includes a first support portion supporting the first end portion of the tubular body, and
the second end unit includes of a second support portion supporting the second end portion of the tubular body.

9. The fuel cell stack according to claim 8, wherein
each of the plurality of power generation cells includes a unitized electrode assembly and a pair of separators disposed on both sides in the predetermined direction of the unitized electrode assembly, the unitized electrode assembly including a membrane electrode assembly configured as a joint body of an electrolyte membrane and an electrode and a frame supporting the membrane electrode assembly,
the gas supply flow path is formed by a through hole provided in the frame and through holes provided in the pair of separators, and
the frame includes a third support portion around the through hole provided in the frame to support an intermediate portion in the predetermined direction of the tubular body.

10. The fuel cell stack according to claim 8, wherein
the first support portion includes a bulge bulging downward from an edge on an upper side of the supply port of the first end unit, and
the first end portion of the tubular body is supported by being inserted into a through hole penetrating the bulge in the predetermined direction.
